(19) United States
(12) Patent Application Publication
(10) Pub. No.: US 2025/0043039 A1
(43) Pub. Date: Feb. 6, 2025

(54) HALOGEN RECOVERY WITH OXIDANT AND PHASE TRANSFER CATALYST IN A PROCESS FOR HALOGENATING UNSATURATED ISOOLEFIN COPOLYMER

(71) Applicant: ARLANXEO SINGAPORE PTE. LTD., Singapore (SG)

(72) Inventors: Kai CAO, London (CA); Gregory J. E. DAVIDSON, London (CA)

(21) Appl. No.: 18/712,986

(22) PCT Filed: Dec. 8, 2022
(86) PCT No.: PCT/CA2022/051790

§ 371 Date: May 23, 2024

(30) Foreign Application Priority Data
Dec. 13, 2021 (EP) 21214084.2

(51) Int. Cl. C08F 8/22

(52) U.S. Cl. CPC C08F 8/22

(57) ABSTRACT

A process for producing a halogenated isoolefin copolymer involves contacting an unsaturated isoolefin copolymer cement, the cement comprising an unsaturated isoolefin copolymer dissolved in an organic solvent, under halogenation conditions with a halogenating agent and an aqueous solution of an oxidant and a phase transfer catalyst to form a two-phase reaction medium comprising an organic phase and an aqueous phase, the oxidant capable of converting hydrogen halide to free halogen and the phase transfer catalyst being a compound of Formula (I): Formula (I) where: M⁺ is a cation of a Group VA element; X⁻ is an anion that dissociates from the cation in an aqueous solution; and, R₁, R₂, R₃ and R₄ are the same or different and are independently a C₁₋₃₀ organic moiety. The process provides improved halogen recovery, is less sensitive to the presence of water, and can make use of a variety of different oxidants.

### CROSS-REFERENCE TO RELATED APPLICATIONS

This application claims priority to European patent application 21214084.2 filed Dec. 13, 2021, the entire contents of which is herein incorporated by reference.

### FIELD

This application relates to a process for halogenating an unsaturated isoolefin copolymer.

### BACKGROUND

In the standard process for brominating butyl rubber to form bromobutyl rubber, molecular bromine (Br₂) is used as the brominating agent. The process results in the evolution of hydrogen bromide (HBr), as a by-product which, under normal conditions, does not further brominate the butyl rubber polymer. Therefore, the theoretical maximum fraction of bromine present in the reaction mixture which can be introduced into the butyl rubber polymer is 50%. However, in practice the fraction is usually less than 45%, and is less than 35% in both laboratory and production plant settings.

Known methods (WO 2020/124222, US 2014/0309362, U.S. Pat. Nos. 3,018,275, 5,681,901) to enhance bromine utilization during butyl rubber bromination involve the application of at least 0.5 mol per mol of brominating agent of a water-soluble oxidizing agent, such as organic peracid or hydrogen peroxide, which re-oxidizes the hydrogen bromide back to elemental bromine. The oxidizing agent can be an aqueous solution, or an aqueous emulsion in an organic solvent. Since the oxidizing agent is only soluble in water, the rate of reaction is governed by the rate in which the reactants can exchange between the organic and aqueous phases, thus requiring a longer reaction time.

Further, the methods utilizing hydrogen peroxide require very low concentrations of water to be present in the bromination medium. The benefits observed from the use of hydrogen peroxide in the bromination medium decrease dramatically with water concentrations greater than 1 wt %, presenting significant challenges and cost industrially, because additional equipment and energy may be needed to reduce the water content in the bromination medium from 10-20 wt % down to below 1 wt %.

In addition, some processes involve post-halogenation recycling by neutralizing HBr to yield sodium bromide (NaBr), washing the NaBr from the halogenated butyl rubber into the aqueous stream, and converting the NaBr to Br₂ using Cl₂ gas, for example by the Blowout Process. This ex-situ recycling method is limited by extraction efficiency of NaBr into the aqueous phase and dilution of the NaBr in the aqueous phase. Further, performing such an ex-situ process is cost ineffective and energy intensive.

Despite phase transfer catalysts, such as quaternary ammonium salts, being widely used in the synthesis of organic compounds in biphasic reactions (U.S. Pat. No. 3,992,432), the use of phase transfer catalysts directed to halogen recovery during polymer halogenation reactions remains unexplored. In EP 0344021, the use of methyl trialkyl ammonium chloride as a phase transfer catalyst in the chlorination of para-alkylstyrene copolymers is disclosed in the context of selectively chlorinating the para-alkyl group. However, both the use of a phase transfer catalyst for halogen recovery and the effect of a phase transfer catalyst on eliminating water sensitivity of a halogenation reaction are not disclosed. Further, in EP 0344021, the oxidant is the chlorinating agent for the polymer and the oxidant is not used to convert hydrogen halide and/or halide ions back into a halogenating agent. As such, there is no halogen recycling in EP 0344021.

There remains a need for a cost-effective, efficient process for improving halogen utilization during halogenation of an isoolefin copolymer, for example butyl rubber, especially in the presence of significant amounts of water.

### SUMMARY

It has now been found that quaternary salts, preferably quaternary ammonium salts, used as phase transfer catalysts for oxidants during a bromine recovery process reduce or eliminate water sensitivity and improve bromine recovery at given amounts of the oxidants.

In one aspect, there is provided a process for producing a halogenated isoolefin copolymer, the process comprising contacting an unsaturated isoolefin copolymer cement, the cement comprising an unsaturated isoolefin copolymer dissolved in an organic solvent, under halogenation conditions with a halogenating agent and an aqueous solution of an oxidant and a phase transfer catalyst to form a two-phase reaction medium comprising an organic phase and an aqueous phase, the oxidant capable of converting hydrogen halide to free halogen and the phase transfer catalyst being a compound of Formula (I):

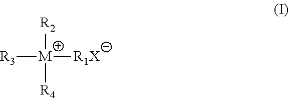

where: M⁺ is a cation of a Group VA element; X⁻ is an anion that dissociates from the cation in an aqueous solution; and, R₁, R₂, R₃ and R₄ are the same or different and are independently a C₁₋₃₀ organic moiety.

The present halogenation process advantageously results in increased halogen utilization by oxidizing hydrogen halide (HX) formed during halogenation of the unsaturated isoolefin copolymer back to molecular halogen (X₂). The process has less sensitivity to the presence of water in the cement, provides as good or better bromine recovery compared to similar processes (e.g., processes utilizing peracid alone or hydrogen peroxide alone) while using less oxidant, and can utilize a variety of different oxidants. The process does not radically affect the microstructure and molecular weight of the resulting halogenated isoolefin copolymer, and the ability to use less oxidant to achieve the same or better halogenation efficiency is further beneficial to maintaining the microstructure and molecular weight of the halogenated isoolefin copolymer.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a graph of functional bromine (mol %) vs. reaction time (mins) showing the effect of reaction time on bromine recovery when using NaClO as an oxidant and tetrabutylammonium hydrogensulfate (PTC 1) as a phase transfer catalyst.

FIG. 2 depicts a graph of functional bromine (mol %) vs. stirring rate (rpm) showing the effect of stirring rate on bromine recovery when using NaClO as an oxidant and tetrabutylammonium hydrogensulfate (PTC 1) as a phase transfer catalyst.

FIG. 3 depicts a graph of bromine atom efficiency (BAE) (%) vs. amount of phase transfer catalyst (mmol) showing the effect of the amount of phase transfer catalyst on bromine recovery when using NaClO as an oxidant and tetrabutylammonium hydrogensulfate (PTC 1) as a phase transfer catalyst.

FIG. 4 depicts a graph of functional bromine (mol %) vs. time (mins) showing the effect of reaction time on bromine recovery when using NaBrO₃ as an oxidant and tetrabutylammonium hydrogensulfate (PTC 1) as a phase transfer catalyst.

FIG. 5 depicts a graph of bromine atom efficiency (BAE) (%) vs. water concentration (wt %) showing the effect of water content on bromine recovery when using NaClO as an oxidant and tetrabutylammonium hydrogensulfate (PTC 1) or methyltrioctylammonium hydrogen sulfate (PTC 3) as phase transfer catalyst.

### DETAILED DESCRIPTION

The process involves polymerizing at least one isoolefin monomer and at least one copolymerizable unsaturated monomer in an organic diluent to produce a halogenatable isoolefin copolymer in an organic medium. Polymerization occurs in a polymerization reactor. Suitable polymerization reactors include flow-through polymerization reactors, plug flow reactor, moving belt or drum reactors, and the like. The process preferably comprises slurry polymerization of the monomers.

The halogenatable isoolefin copolymer preferably comprises repeating units derived from at least one isoolefin monomer and repeating units derived from at least one copolymerizable unsaturated monomer, and optionally repeating units derived from one or more further copolymerizable monomers. The halogenatable isoolefin copolymer preferably comprises an unsaturated isoolefin copolymer.

Suitable isoolefin monomers include hydrocarbon monomers having 4 to 16 carbon atoms. In one embodiment, the isoolefin monomers have from 4 to 7 carbon atoms. Examples of suitable isoolefins include isobutene (isobutylene), 2-methyl-1-butene, 3-methyl-1-butene, 2-methyl-2-butene, 4-methyl-1-pentene, 4-methyl-1-pentene and mixtures thereof. A preferred isoolefin monomer is isobutene (isobutylene).

Suitable copolymerizable unsaturated monomers include multiolefins, p-methyl styrene, β-pinene or mixtures thereof. Multiolefin monomers include hydrocarbon monomers having 4 to 14 carbon atoms. In some embodiments, the multiolefin monomers are conjugated dienes. Examples of suitable conjugated diene monomers include isoprene, butadiene, 2-methylbutadiene, 2,4-dimethylbutadiene, piperylene, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 4-butyl-1,3-pentadiene, 2,3-dimethyl-1,3-pentadiene, 2,3-dibutyl-1,3-pentadiene, 2-ethyl-1,3-pentadiene, 2-ethyl-1,3-butadiene, 2-methyl-1,6-heptadiene, cyclopentadiene, methylcyclopentadiene, cyclohexadiene, 1-vinyl-cyclohexadiene and mixtures thereof.

The halogenatable isoolefin copolymer may optionally include one or more additional copolymerizable monomers. Suitable additional copolymerizable monomers include, for example, styrenic monomers, such as alkyl-substituted vinyl aromatic comonomers, including but not limited to a C₁-C₄ alkyl substituted styrene. Specific examples of additional copolymerizable monomers include, for example, α-methyl styrene, p-methyl styrene, chlorostyrene, cyclopentadiene and methylcyclopentadiene. Indene and other styrene derivatives may also be used. In one embodiment, the halogenatable isoolefin copolymer may comprise random copolymers of isobutylene, isoprene and p-methyl styrene.

In one embodiment, the halogenatoable isoolefin copolymer may be formed by copolymerization of a monomer mixture. Preferably, the monomer mixture comprises about 80-99.9 mol % of at least one isoolefin monomer and about 0.1-20 mol % of at least one copolymerizable unsaturated monomer, based on the monomers in the monomer mixture. More preferably, the monomer mixture comprises about 90-99.9 mol % of at least one isoolefin monomer and about 0.1-10 mol % of at least one copolymerizable unsaturated monomer. In one embodiment, the monomer mixture comprises about 92.5-97.5 mol % of at least one isoolefin monomer and about 2.5-7.5 mol % of at least one copolymerizable unsaturated monomer. In another embodiment, the monomer mixture comprises about 97.4-95 mol % of at least one isoolefin monomer and about 2.6-5 mol % of at least one copolymerizable unsaturated monomer.

If the monomer mixture comprises the additional copolymerizable with the isoolefins and/or copolymerizable unsaturated monomers, the additional copolymerizable monomer preferably replaces a portion of the copolymerizable unsaturated monomer. When a multiolefin monomer is used, the monomer mixture may also comprise from 0.01% to 1% by weight of at least one multiolefin cross-linking agent, and when the multiolefin cross-linking agent is present, the amount of multiolefin monomer is reduced correspondingly.

The unsaturated isoolefin copolymer may be prepared by any suitable method, of which several are known in the art. For example, the polymerization of monomers may be performed in a diluent in the presence of an initiator system (e.g., a Lewis acid catalyst and a proton source) capable of initiating the polymerization process. A proton source suitable in the present invention includes any compound that will produce a proton when added to the Lewis acid or a composition containing the Lewis acid. Protons may be generated from the reaction of the Lewis acid with proton sources to produce the proton and the corresponding by-product. Such reaction may be preferred in the event that the reaction of the proton source is faster with the protonated additive as compared with its reaction with the monomers. Proton generating reactants include, for example such as water, alcohols, phenol thiols, carboxylic acids, and the like or any mixture thereof. Water, alcohol, phenol or any mixture thereof is preferred. The most preferred proton source is water. A preferred ratio of Lewis acid to proton source is from 5:1 to 100:1 by weight, or from 5:1 to 50:1 by weight. The initiator system including the catalyst and proton source is preferably present in the reaction mixture in an amount of 0.02-0.1 wt %, based on total weight of the reaction mixture.

Alkyl aluminum halide catalysts are a particularly preferred class of Lewis acids for catalyzing solution polymerization reactions in accordance with the present invention. Examples of alkyl aluminum halide catalysts include methyl aluminum dibromide, methyl aluminum dichloride, ethyl aluminum dibromide, ethyl aluminum dichloride, butyl aluminum dibromide, butyl aluminum dichloride, dimethyl aluminum bromide, dimethyl aluminum chloride, diethyl aluminum bromide, diethyl aluminum chloride, dibutyl aluminum bromide, dibutyl aluminum chloride, methyl aluminum sesquibromide, methyl aluminum sesquichloride, ethyl aluminum sesquibromide, ethyl aluminum sesquichloride and any mixture thereof. Preferred are diethyl aluminum chloride (Et₂AlCl or DEAC), ethyl aluminum sesquichloride (Et_{1.5}AlCl_{1.5} or EASC), ethyl aluminum dichloride (EtAlCl₂ or EADC), diethyl aluminum bromide (Et₂AlBr or DEAB), ethyl aluminum sesquibromide (Et_{1.5}AlBr_{1.5} or EASB) and ethyl aluminum dibromide (EtAlBr₂ or EADB) and any mixture thereof. In a particularly preferred initiator system, the catalyst comprises ethyl aluminum sesquichloride, preferably generated by mixing equimolar amounts of diethyl aluminum chloride and ethyl aluminum dichloride, preferably in a diluent. The diluent is preferably the same one used to perform the copolymerization reaction.

The diluent may comprise an organic diluent. Suitable organic diluents may include, for example, alkanes, chloroalkanes, cycloalkanes, aromatics, hydrofluorocarbons (HFC) or any mixture thereof. Chloroalkanes may include, for example methyl chloride, dichloromethane or any mixture thereof. Methyl chloride is particularly preferred. Alkanes and cycloalkanes may include, for example, isopentane, cyclopentane, 2,2-dimethylbutane, 2,3-dimethylbutane, 2-methylpentane, 3-methylpentane, n-hexane, methylcyclopentane, 2,2-dimethylpentane or any mixture thereof. Alkanes and cycloalkanes are preferably C6 solvents, which include n-hexane or hexane isomers, such as 2-methyl pentane or 3-methyl pentane, or mixtures of n-hexane and such isomers as well as cyclohexane. The monomers are generally polymerized cationically in the diluent at temperatures in a range of from −120° C. to +20° C., preferably −100° C. to −50° C., more preferably −95° C. to −65° C. The temperature is preferably about −80° C. or colder.

Where the diluent comprises chloroalkanes (e.g., methyl chloride) in a slurry polymerization process, the diluent as well as any residual monomers may be removed from the unsaturated isoolefin copolymer by flash separation using steam. Removal of the diluent and residual monomers in such a ‘wet’ process leaves a polymer containing a significant amount of water. The polymer is dissolved in organic solvent to provide a polymer cement having a significant water content, for example 1 wt % or greater or 1.5 wt % or greater, based on total weight of the cement. In some embodiments, the water content of the cement may be 0-30 wt % or 0-25 wt %, 1-30 wt % or 1.5-15 wt % or 2-30 wt % or 2-20 wt % or 2-15 wt % or 5-20 wt % or 5-15 wt % or 5-10 wt % or 10-15 wt %, based on total weight of the cement.

Where the diluent comprises chloroalkanes (e.g., methyl chloride) or alkanes (e.g., hexanes) in a slurry or a solution polymerization process, the diluent as well as any residual monomers may be removed from the unsaturated isoolefin copolymer by flash separation using a heated organic solvent in which the unsaturated isoolefin copolymer is soluble or by simple distillation. Where simple distillation is used, some of the organic diluent may remain as organic solvent in the cement. Removal of the diluent and residual monomers in such a ‘dry’ process provides a polymer cement containing less water, for example less than 1 wt %, or even 0 wt %, water based on total weight of the cement.

To form the halogenated isoolefin copolymer, the unsaturated isoolefin copolymer may be subjected to a halogenation process using a halogenating agent under halogenation conditions. Halogenation can be performed by adapting a process known by those skilled in the art (for example the procedures described in Rubber Technology, 3rd Ed., Edited by Maurice Morton, Kluwer Academic Publishers, pp. 297-300 or United States Patent U.S. Pat. No. 5,886,106 issued Mar. 23, 1999, the contents of both of which are herein incorporated by reference) and modifying the process as described herein.

To improve efficiency of halogenation, the halogenation process is modified by contacting an unsaturated isoolefin copolymer cement, in which the unsaturated isoolefin copolymer is dissolved in an organic solvent, with a halogenating agent and an aqueous solution of an oxidant and a phase transfer catalyst. A two-phase reaction medium comprising an organic phase and an aqueous phase is formed. The oxidant in-situ oxidizes halide produced in the halogenation process back into free (i.e., molecular halogen) to improve halogen atom efficiency of the halogenation process.

Halogenating agents useful for halogenating the unsaturated isoolefin copolymer may comprise molecular chlorine (Cl₂) or molecular bromine (Br₂) and/or organo-halide or inorganic halide precursors thereto, for example dibromo-dimethyl hydantoin, tri-chloroisocyanuric acid (TClA), n-bromosuccinimide, sodium bromide, hydrogen bromide or the like. Preferably, the halogenating agent comprises chlorine (Cl₂) or bromine (Br₂), more preferably bromine. Preferably, halogenation comprises bromination. The amount of halogenating agent added is controlled to provide a final halogen content of at least 0.05 mol %, preferably 0.05-2.5 mol %, in the halogenated isoolefin copolymer. The amount of halogenating agent used has a linear relationship with the final halogen content (i.e., the functional halogen amount) on the halogenated isoolefin copolymer. A larger amount of halogenating agent leads to a larger functional halogen amount in the halogenated isoolefin copolymer.

Halogenation is performed in a reaction medium comprising an organic solvent. The organic solvent is preferably an aliphatic solvent. The organic solvent preferably comprises an alkane, more preferably hexanes or pentanes.

Halogenation may be conducted for a length of time to achieve the desired level of halogenation. The length of time is preferably 60 minutes or less. Even at 20 minutes or less, or at 10 minutes or less, or at 5 minutes or less, significant halogenation of the unsaturated isoolefin copolymer may be achieved. Preferably, halogenation is conducted for a minimum of 1 minute. Preferably, the halogenation time is 1-60 minutes, or 1-20minutes, or 1-10 minutes, or 1-5 minutes.

Halogenation may be conducted at any suitable temperature and is preferably conducted at a temperature up to about 90° C. In some embodiments, the temperature may be up to about 80° C. In other embodiments, the temperature may be up to about 65° C. The increased halogenation efficiency at lower temperatures is more pronounced at higher concentrations of the unsaturated isoolefin copolymer in the reaction medium. Temperatures in a range of 0-70° C. or 0-50° C. or 0-45° C. or 15-45° C. or 20-45° C. or 40-45° C. or 30-70° C. or 20-60° C. or 23-54° C. or 23-45° C. or 10-35° C. or 20-30° C. are preferred. In one embodiment, the unsaturated isoolefin copolymer is cooled before contacting the solution of the unsaturated isoolefin copolymer cement with the halogenating agent and the aqueous solution of oxidant.

Halogenation may be conducted with or without mixing the reaction medium. Preferably, the reaction medium is mixed during halogenation. Mixing can be accomplished by any suitable method, for example by stirring, agitating and the like. More preferably, the reaction medium is stirred, preferably at a rate of 600 rpm or more. Stirring is more preferably accomplished with a mechanical stirrer.

The unsaturated isoolefin copolymer is preferably present in the reaction medium in an amount of 1-60 wt %, based on total weight of the reaction medium. More preferably, the unsaturated isoolefin copolymer is present in an amount of 5-50 wt %, even more preferably 5-40 wt %, yet more preferably 10-33 wt %, even yet more preferably 10-30 wt %, for example 25 wt %, based on total weight of the reaction medium.

The aqueous phase is formed from the aqueous solution of oxidant and phase transfer catalyst, from water generated by the halogenation reaction and from any additional water contained in the unsaturated isoolefin polymer cement. The aqueous solution of oxidant and phase transfer catalyst together with the water generated by the halogenation reaction typically form less than 4 wt % of the reaction medium, for example 0.16-3.6 wt %, based on total weight of the reaction medium.

The reaction medium may contain 0-20 wt %, based on total weight of the reaction medium, of additional water arising from water contained in the unsaturated isoolefin polymer cement depending on the process used to prepare the polymer cement. The additional water is water from the unsaturated isoolefin polymer cement and does not include the water used to prepare the aqueous solution of the oxidant or the water generated by the halogenation reaction. It is an advantage of the present process that the reaction medium may contain significant amounts of additional water, for example 1-20 wt % additional water, based on total weight of the reaction medium. In some embodiments, the additional water may comprise or 1.5-15 wt % or 2-20 wt % or 2-15 wt % or 5-20 wt % or 5-15 wt % or 5-10 wt % of the reaction medium, based on total weight of the reaction medium. Even so, in some embodiments the reaction medium may contain an insignificant amount of additional water, for example less than 1 wt % additional water, or even 0 wt % additional water, based on total weight of the reaction medium.

The oxidant may be any suitable oxidant for converting hydrogen halide to free halogen. Some examples include hydrogen peroxide, metal salts of hydrogen peroxide, organic peracids, metal salts of organic peracids, inorganic oxyacids, metal salts of inorganic oxyacids, and the like, and mixtures thereof. Metal salts preferably comprise alkali metal cations (e.g., Li⁺, Na⁺, K⁺ or mixtures thereof) as the metal of the salt. In some embodiments, the oxidant comprises H₂O₂, NaHSO₅, Na₂S₂Oₛ, NaClO, NaBrO, NaBrO₃, NaIO₂, NaClO, NaClO₂, NaClO₄, NaIO₄, NaOO(CO)R₅ where R₅ is a C₁₋₈ alkyl moiety, KHSO₅, K₂S₂O₈, KClO, KBrO, KBrO₃, KIO₃, KClO₃, KClO₄, KIO₄, KOO(CO)R₅ where R₅ is a C₁₋₈ alkyl moiety, compounds that generate the aforementioned oxidants, or mixtures thereof.

The phase transfer catalyst (PTC) forms an ionic association and/or a hydrogen bond with an oxidant molecule, or an oxidant anion thereof, to facilitate transfer of the oxidant into the organic phase. The phase transfer catalyst extracts the oxidant molecule or oxidant anion thereof from the aqueous phase into the organic phase. The counter anion of the phase transfer catalyst, and the metal cation associated with the oxidant anion when such is present, remain in the aqueous phase. The use of a phase transfer catalyst together with the oxidant increases bromine recovery efficiencies beyond efficiencies reported in prior art processes.

The phase transfer catalyst is a compound of Formula (I) as described above. Preferably, the Group VA element is N or P, more preferably N. Preferably, the phase transfer catalyst is a quaternary ammonium salt. Preferably, the anion is a halide (e.g., F, Cl, Br, I), OH⁻, HSO4⁻, BF₄⁻, NO₃⁻, CF₃SO₃⁻, CH₃C₆H₄SO₃⁻, CH₃COO⁻, ICl₂⁻, ClO₄⁻, SO₄²⁻, SCN, PF₆⁻, HF₂⁻. More preferably, the anion is Cl, Br, OH⁻ or HSO₄⁻. Preferably, R₁, R₂, R₃ and R₄ are the same or different and are independently aliphatic hydrocarbyl moieties, aromatic hydrocarbyl moieties or both aliphatic hydrocarbyl moieties and aromatic hydrocarbyl moieties. More preferably, R₁, R₂, R₃ and R₄ are the same or different and are independently alkyl, aryl, alkaryl, aralkyl or cycloalkyl moieties. Yet more preferably, R₁, R₂, R₃ and R₄ are the same or different and are independently C₁₋₃₀ linear alkyl moieties or C₆-C₁₆ aralkyl moieties. Even yet more preferably, R₁, R₂, R₃ and R₄ are the same or different and are independently C₁₋₁₀ linear alkyl moieties or C₆-C₁₁ aralkyl moieties.

In a particularly preferred embodiment, R₁, R₂, R₃ and R₄ together comprise a total of 25 or more carbon atoms. When the total number of carbon atoms is equal or larger than 25, halogen recovery without water sensitivity is achieved. The total number of carbon atoms is preferably 120 or less, more preferably 40 or less.

Some particularly preferred examples of the compound of Formula (I) are tetramethylammonium hydroxide, ethyl trimethylammonium iodide, triethylmethylammonium chloride, tetraethylammonium hydrogen sulfate, tetraethylammonium chloride, tetrabutylammonium bromide, tetrabutylammonium hydrogensulfate, n-octyltrimethylammonium chloride, methyltrioctylammonium hydrogen sulfate, tetrahexylammonium hydrogensulfate, tetra-n-octylammonium iodide, diauryldimethylammonium bromide, benzyltrimethylammonium bromide or mixtures thereof.

The phase transfer catalyst is preferably used in an amount whereby the phase transfer catalyst and the oxidant are present in the aqueous solution in a molar ratio of phase transfer catalyst to oxidant of 0.005 or more, More preferably, the molar ratio of phase transfer catalyst to oxidant is 0.006 or more, or 0.01 or more, or 0.013 or more. The molar amount of phase transfer catalyst in comparison to the oxidant can be small while producing effective increases in halogen recovery, but large amounts of phase transfer catalyst can be utilized. For example, the molar ratio of phase transfer catalyst to oxidant can be as high as 10 or even higher. However, in many embodiments, the molar ratio of phase transfer catalyst to oxidant is preferably no more than 10, more preferably no more than 1. Preferably, the amount of phase transfer catalyst is at least 0.13 mmol, more preferably at least 0.2 mmol or at least 0.25 mmol.

The oxidant and phase transfer catalyst are preferably premixed in the aqueous solution prior to introducing the aqueous solution into the reaction medium the cement, but it is possible under some circumstances to introduce the oxidant and phase transfer catalyst separately into the reaction medium containing the cement, preferably by adding the phase transfer catalyst first, followed by the oxidant. The oxidant and phase transfer catalyst are preferably added to the reaction medium prior to introducing the halogenating agent.

The concentration of oxidant present in the reaction medium is preferably at least 0.06 moles of oxidant per mole of halogenating agent, or at least 0.1 moles of oxidant per mole of halogenating agent. The concentration of oxidant present in the reaction medium is preferably 0.2-5 moles, more preferably 0.25-4 moles, yet more preferably 0.5-3 moles, of oxidant per mole of halogenating agent. The desired concentration of oxidant is a function of the desired halogenation time. For a halogenation time of 5 minutes, 0.5-2 moles, for example 2 moles, of oxidant per mole of halogenating agent is preferred. Lower concentrations of oxidant may be offset by longer halogenation time. Adjusting stirring rate of the reaction medium can lead to improvement in the efficiency of the halogenation.

In the present process, all or some of the halogenating agent may comprise hydrogen halide (HX) added to the aqueous phase. Because HX is converted into molecular halogen (X₂) by the oxidant in the aqueous phase, the added HX can act as a source of halogenating agent.

### EXAMPLES

Scheme 1 illustrates an example of the process for producing a halogenated isoolefin copolymer. As illustrated in Scheme 1, with Br₂ as the halogenating agent, a suitable oxidant and a phase transfer catalyst, the phase transfer catalyst ionically associates with and/or hydrogen bonds to an oxidant anion. In this manner, the phase transfer catalyst is able to extract the oxidant anion from the aqueous phase to effect oxidation of the HBr produced in the organic phase back into Br₂. In addition, bromide ions that migrate into the aqueous phase can be oxidized by the oxidant anion to reform Br₂, which will preferentially transfer back into the organic phase. In this way, the efficiency of bromine usage in the bromination reaction can be increased. In some cases, for example when the oxidant is hydrogen peroxide, the phase transfer catalyst extracts the oxidant molecule into the organic phase.

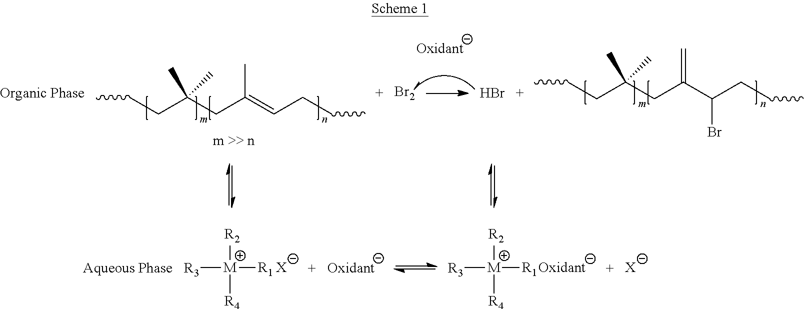

### Materials and Methods:

Isobutylene-isoprene polymer (IIR) and Epoxidized Soybean Oil (ESBO) were obtained from ARLANXEO (Sarnia, Ontario, Canada site). The remaining materials were used as received: Sodium Hypochlorite (available chlorine 10-15%, Sigma-Aldrich), Sodium Bromate (Sigma-Aldrich), Potassium Peroxymonosulfate (Oxone™ with active oxygen greater than 4 wt % from Sigma Aldrich), Hexanes (VWR), Sodium Hydroxide (VWR), 99.99% Bromine (Sigma Aldrich), 35 wt % Peracetic Acid Solution (Evonik), 30 wt % Hydrogen Peroxide (Sigma-Aldrich), Glacial Acetic Acid (Sigma-Aldrich), 95-98% Sulfuric Acid (Sigma-Aldrich), Calcium Stearate (Alfa Aesar) and Irganox™-1010 (BASF), Tetramethylammonium Hydroxide (Sigma-Aldrich), Tetrabutylammonium Hydrogensulfate (Sigma-Aldrich), Tetrabutylammonium Bromide (Sigma-Aldrich), Methyltrioctylammonium Hydrogensulfate (Sigma-Aldrich). Benzyltrimethylammonium bromide (Sigma-Aldrich).

Scheme 2 shows the structures of the phase transfer catalysts (PTC) that were used in the Examples. PTC 0 is tetramethylammonium hydroxide. PTC 1 is tetrabutylammonium hydrogensulfate. PTC 2 is tetrabutylammonium bromide. PTC 3 is methyltrioctylammonium hydrogen sulfate. PTC 4 is benzyltrimethylammonium bromide.

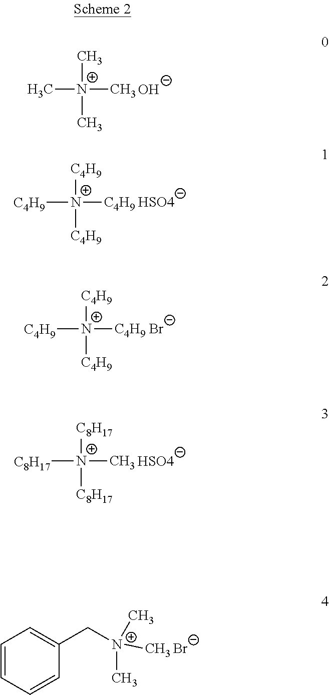

### Bromination Reactions

250 g of isobutylene-isoprene copolymer (butyl rubber, IIR) was cut into small pieces and added to a 5 L jacketed reactor equipped with an overhead stirrer, and prefilled with 1053 mL of hexanes. Stir speed was set to 150 rpm while the base material pieces were added to the reactor. The solution was stirred for 24 hours to fully dissolve the butyl rubber. After the isobutylene-isoprene copolymer had fully dissolved, 60 ml of water was added to the reactor via a pipette to provide a butyl rubber cement. In Examples where an oxidant except for Oxone was used for bromine recovery, the oxidant and phase transfer catalyst were first dispersed in 4 mL water/4 mL hexane mixed solvent, followed by the addition of the resulting solution to the reactor before the addition of bromine. Examples where Oxone was used for bromine recovery, Oxone and phase transfer catalyst were first dissolved in 25 ml water/4 mL hexane. The amounts of oxidant and phase transfer catalyst are shown in the Examples.

A circulating bath connected to the jacketed reactor was set to 45° C. to heat reactor and the butyl rubber cement was stirred at 350 rpm for 30 minutes. Then bromine (Br₂) (1.76 mL, 5.49 g, 0.0343 moles) was added with a syringe, and the reaction was stirred for 5 mins or 1-hour in some examples.

For the brominations with 1-hour period, 10 mL samples of the reaction medium were extracted with a pipette at 5, 20, 40 and 60 minutes, and added to vials containing 10 mL of 2.5 M NaOH, whereupon the vials were shaken vigorously to quench residual bromine, HBr and oxidant. The halogenated polymer samples in the vial were then collected by precipitating the polymer solution into ethanol and drying the precipitate under vacuum at 60° C. for 48 h.

After 5 mins or 1-hour period, pre-determined amount of a 2.5 M NaOH solution was added to the remaining reaction medium to quench the reaction. An additional 250 mL of water was added to aid in mixing. The mixture was continued to stir at 350 rpm for 5 minutes. An additional 1 L of water was added and allowed to stir at 350 rpm for another 5 minutes. Stirring was reduced to 150 rpm and the was stirred for an additional 5 minutes. The reactor stirring was stopped and the water phase was drained through the bottom drain valve. The cement of brominated isobutylene-isoprene copolymer was washed with additional water until the pH was 7, to remove any residual inorganic salts. A solution of polymer stabilizers (4.52 g of calcium stearate, 0.125g of Irganox™-1010, and 3.25 g of ESBO) in hexanes was added to the reactor and the cement stirred for 5 minutes. The cement was drained and steam coagulated using low pressure steam for about 1 hour. A small piece of the brominated polymer sample was cut from the final product and dried in the vacuum oven at 60° C. overnight.

The micro-structures and bromine content of the dry samples were analyzed using ¹H-NMR spectroscopy.

### Bromine Utilization Calculations

Bromine utilization in the bromination process may be measured using bromine atom efficiency (BAE), which is given by the following equation:

$$B AE ( \% ) = \frac{atoms of Br on polymer}{atoms of Br from bromine added to reaction} \times 100 \%$$

Atoms of Br on polymer is calculated from ¹H-NMR. Atoms of Br from bromine added to the reaction is calculated by volume of bromine used in reaction. From the equation, it is evident that ideal conditions would yield a BAE of 50%, where 50% of the Br is in waste HBr. Therefore, the theoretical maximum fraction of bromine present in the reaction mixture which can be introduced into the butyl rubber polymer is 50%. However, in practice the BAE is usually less than 45%, for example 30-45% or 35-45%.

In some previous methods (e.g., in U.S. Pat. Nos. 3,018,275 and 5,681,901) bromine utilization is measured using molecules of molecular bromine added to the reaction, which provides numerical results that are double the BAE because there are two atoms of bromine in every molecule of molecular bromine. Further, these previous methods use X-ray diffraction in order to estimate the amount of Br bound to the polymer. However, this method will also measure NaBr arising from the neutralization process, and which is trapped within the polymer matrix. Trapped NaBr does not necessarily measure the amount of Br chemically bound to the polymer, and generally provides numbers for bromine utilization efficiency that are higher than the actual efficiency.

### Example 1: Control without Using Phase Transfer Catalyst (PTC)

A control experiment was conducted using NaClO (sodium hypochlorite) as the oxidant. It is apparent from Table 1 that increasing the amount of oxidant increases bromine recovery.

TABLE 1
IIR (25 wt %), Water (6 wt %), Temperature
(45° C.), Br₂ (0.034 moles), 600 rpm, 5 min

| | NaClO | NaClO | PTC | Functional | BAE |
|---|---|---|---|---|---|
| Process | (mmol) | (mL) | (mmol) | Br (mol %) | (%) |
| C1 | 0 | 0 | 0 | 0.56 | 36.3 |
| C2 | 40.5 | 20 | 0 | 0.75 | 48.6 |
| C3 | 60.75 | 30 | 0 | 0.88 | 57.0 |

### Example 2: Effect of Phase Transfer Catalyst on Bromine Recovery

Using NaClO as the oxidant and PTC 1 as the phase transfer catalyst, the effect of the phase transfer catalyst on bromine recovery was investigated. It is apparent from Table 2 comparing C2 to P1 that the use of a small amount of quaternary salt phase transfer catalyst increases functional bromine compared to bromination without phase transfer catalyst using the same oxidant and the same amount of oxidant. Likewise, comparing C3 to P1, the use of a phase transfer catalyst reduces the amount of oxidant required to achieve the same functional bromine. Reducing the amount of oxidant is beneficial for preserving the microstructure of the brominated butyl rubber.

TABLE 2
IIR (25 wt %), Water (6 wt %), Temperature
(45° C.), Br₂ (0.034 moles), 600 rpm, 5 min

| | NaClO | | Functional | BAE |
|---|---|---|---|---|
| Process | (mmol) | PTC (mmol) | Br (mol %) | (%) |
| C2 | 40.5 | 0 | 0.75 | 48.6 |
| C3 | 60.75 | 0 | 0.88 | 57.0 |
| P1 | 40.5 | 0.79 (PTC1) | 0.87 | 56.4 |

### Example 3: Effect of Reaction Time on Bromine Recovery

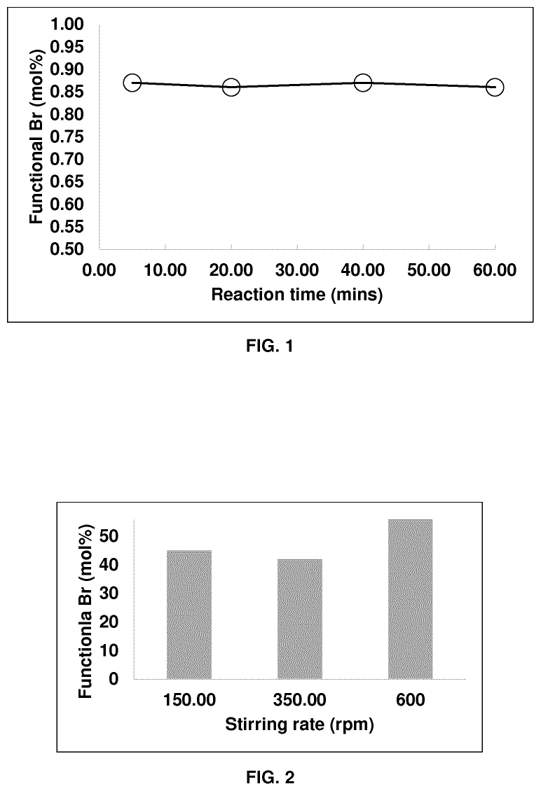

Using NaClO as the oxidant and PTC 1 as the phase transfer catalyst, the effect of reaction time on bromine recovery was investigated. It is apparent from Table 3 and FIG. 1 that longer reaction times are unnecessary for achieving maximum bromine recovery. Maximum bromination of the butyl rubber is achieved within 5 minutes.

TABLE 3
IIR (25 wt %), Water (6 wt %), Temperature
(45° C.), Br₂ (0.034 moles), 600 rpm

| | NaClO | | Time | Functional | BAE |
|---|---|---|---|---|---|
| Process | (mmol) | PTC (mmol) | (min) | Br (mol %) | (%) |
| P1 | 40.5 | 0.79 (PTC1) | 5 | 0.87 | 56.4 |
| P2 | 40.5 | 0.79 (PTC1) | 20 | 0.86 | 55.7 |
| P3 | 40.5 | 0.79 (PTC1) | 40 | 0.87 | 56.4 |
| P4 | 40.5 | 0.79 (PTC1) | 60 | 0.86 | 55.8 |

### Example 4: Effect of Stirring Rate on Bromine Recovery

Using NaClO as the oxidant and PTC 1 as the phase transfer catalyst, the effect of stirring rate on bromine recovery was investigated. It is apparent from Table 4 and FIG. 2 that a higher stirring rate improves bromine recovery.

TABLE 4
IIR (25 wt %), Water (6 wt %), Temperature
(45° C.), Br₂ (0.034 moles), 5 min

| | NaClO | | Stirring | Functional |
|---|---|---|---|---|
| Process | (mmol) | PTC (mmol) | Rate (rpm) | Br (mol %) |
| P5 | 40.5 | 0.79 (PTC1) | 150 | 0.7 |
| P6 | 40.5 | 0.79 (PTC1) | 350 | 0.67 |
| P1 | 40.5 | 0.79 (PTC1) | 600 | 0.87 |

### Example 5: Effect of Different Amounts of Phase Transfer Catalyst on Bromine Recovery

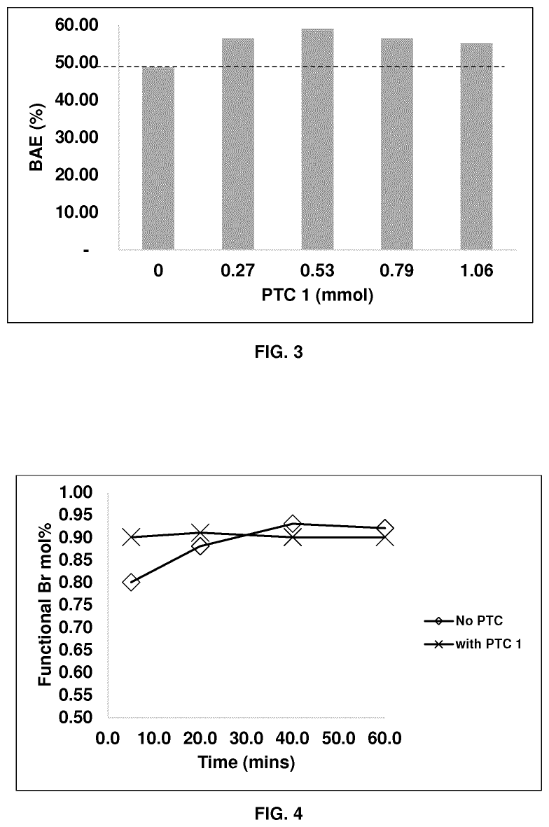

Using NaClO as the oxidant and PTC 1 as the phase transfer catalyst, the effect of different amounts of phase transfer catalyst on bromine recovery was investigated. It is apparent from Table 5 and FIG. 3 that an amount of phase transfer catalyst as low as 0.13 mmol (PTC:oxidant ratio of 0.0032) can achieve efficient bromine recovery. Amounts of phase transfer catalyst of 0.27 mmol (PTC:oxidant ratio of 0.0067) or above provide better results. Amounts of phase transfer catalyst above 0.53 mmol (PTC:oxidant ratio of 0.013) do not improve bromine recovery any further.

TABLE 5
IIR (25 wt %), Water (6 wt %), Temperature
(45° C.), Br₂ (0.034 moles), 600 rpm, 5 min

| | NaClO | | Functional | BAE |
|---|---|---|---|---|
| Process | (mmol) | PTC (mmol) | Br (mol %) | (%) |
| C2 | 40.5 | 0 | 0.75 | 48.6 |
| P7 | 40.5 | 0.13 (PTC1) | 0.76 | 49.2 |
| P8 | 40.5 | 0.27 (PTC1) | 0.87 | 56.4 |
| P9 | 40.5 | 0.53 (PTC1) | 0.91 | 59.0 |
| P1 | 40.5 | 0.79 (PTC1) | 0.87 | 56.4 |
| P10 | 40.5 | 1.06 (PTC1) | 0.85 | 55.1 |

### Example 6: Effect of NaBrO₃ Oxidant with and without Phase Transfer Catalyst on Bromine Recovery

Using NaBrO₃ as the oxidant and PTC 1 as the phase transfer catalyst, the effect of another oxidant on bromine recovery at four different reaction times with and without phase transfer catalyst was investigated. It is apparent from Table 6 and FIG. 4 that quaternary salt phase transfer catalysts work for other Na⁺-containing oxidants. Further, the use of the phase transfer catalyst reduces the amount of time to achieve maximum bromine recovery when NaBrO₃ is used as the oxidant.

TABLE 6
IIR (25 wt %), Water (6 wt %), Temperature
(45° C.), Br₂ (0.034 moles), 600 rpm

| | NaBrO₃ | | Time | Functional | BAE |
|---|---|---|---|---|---|
| Process | (mmol) | PTC (mmol) | (min) | Br (mol %) | (%) |
| C4 | 10.4 | 0 | 5 | 0.80 | 51.9 |
| C5 | 10.4 | 0 | 20 | 0.88 | 57.0 |
| C6 | 10.4 | 0 | 40 | 0.93 | 60.3 |
| C7 | 10.4 | 0 | 60 | 0.92 | 59.6 |
| P11a | 10.4 | 0.37 (PTC1) | 5 | 0.9 | 58.3 |
| P11b | 10.4 | 0.37 (PTC1) | 20 | 0.91 | 59.0 |
| P11c | 10.4 | 0.37 (PTC1) | 40 | 0.9 | 58.3 |
| P11d | 10.4 | 0.37 (PTC1) | 60 | 0.9 | 58.3 |

### Example 7: Effect of Different Phase Transfer Catalysts on Bromine Recovery

Using NaClO as the oxidant and PTC 0, PTC 1, PTC 2, PTC 3 and PTC 4 as the phase transfer catalysts, the effect of different quaternary salt phase transfer catalysts on bromine recovery was investigated. It is apparent from Table 7 that all of the quaternary salt phase transfer catalysts work in a similar manner to increase bromine recovery. Further, less of PTC 3 is required to achieve essentially the same bromine recovery indicating that longer alkyl chains on the phase transfer catalyst lead to requiring less of the phase transfer catalyst.

TABLE 7
IIR (25 wt %), Water (6 wt %), Temperature
(45° C.), Br₂ (0.034 moles), 600 rpm, 5 min

| | NaClO | | Functional | BAE |
|---|---|---|---|---|
| Process | (mmol) | PTC (mmol) | Br (mol %) | (%) |
| P12 | 40.5 | 0.79 (PTC 0) | 0.87 | 56.4 |
| P1 | 40.5 | 0.79 (PTC 1) | 0.87 | 56.4 |
| P13 | 40.5 | 0.79 (PTC 2) | 0.88 | 57.0 |
| P14 | 40.5 | 0.65 (PTC 3) | 0.86 | 55.8 |
| P23 | 40.5 | 0.65 (PTC 4) | 0.82 | 53.2 |

### Example 8: Effect of Water Content on Bromine Recovery

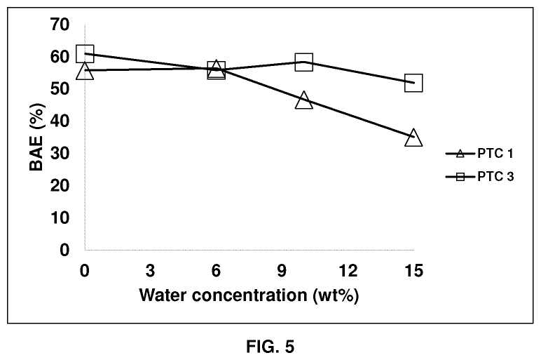

Using NaClO as the oxidant and PTC 1 and PTC 3 as the phase transfer catalysts, the effect of water content of the reaction medium on bromine recovery was investigated. It is apparent from Table 8 and FIG. 5 that bromine recovery is almost insensitive to water content of the reaction medium when PTC 3 is used as the phase transfer catalysts, indicating that quaternary salts with longer alkyl chains provide virtually eliminate water sensitivity of the bromine recovery.

TABLE 8
IIR (25 wt %), Temperature (45°
C.), Br₂ (0.034 moles), 600 rpm, 5 min

| | Water | NaClO | | Functional | BAE |
|---|---|---|---|---|---|
| Process | (wt %) | (mmol) | PTC (mmol) | Br (mol %) | (%) |
| P15a | 0 | 40.5 | 0.79 (PTC 1) | 0.86 | 55.7 |
| P1 | 6 | 40.5 | 0.79 (PTC 1) | 0.87 | 56.4 |
| P15c | 10 | 40.5 | 0.79 (PTC 1) | 0.72 | 46.7 |
| P15d | 15 | 40.5 | 0.79 (PTC 1) | 0.54 | 35.0 |
| P16a | 0 | 40.5 | 0.65 (PTC 3) | 0.94 | 60.9 |
| P14 | 6 | 40.5 | 0.65 (PTC 3) | 0.86 | 55.8 |
| P16c | 10 | 40.5 | 0.65 (PTC 3) | 0.9 | 58.3 |
| P16d | 15 | 40.5 | 0.65 (PTC 3) | 0.8 | 51.9 |

### Example 9: Effect of Different Oxidants on Bromine Recovery

Using potassium peroxymonosulfate (Oxone™), peracetic acid (PAA), in-situ formed PAA and hydrogen peroxide (H₂O₂) as the oxidants and PTC 1, PTC 2 and PTC 3 as the phase transfer catalysts, the effect of different oxidants with different phase transfer catalysts on bromine recovery was investigated.

### Potassium Peroxymonosulfate:

Table 9 shows results obtained using potassium peroxymonosulfate with as the oxidant. It is apparent from Table 9 that the quaternary salt phase transfer catalysts also work with potassium peroxymonosulfate oxidant to improve bromine recovery.

TABLE 9
IIR (25 wt %), Water (6 wt %), Temperature
(45° C.), Br₂ (0.034 moles), 600 rpm, 5 min

| | Oxone ™ | | Functional | BAE |
|---|---|---|---|---|
| Process | (mmol) | PTC (mmol) | Br (mol %) | (%) |
| C1 | 0 | 0 | 0.56 | 36.3 |
| C8 | 22.1 | 0 | 0.81 | 52.5 |
| P17 | 22.1 | 0.79 (PTC 1) | 0.84 | 54.4 |
| P18 | 22.1 | 0.79 (PTC 2) | 0.86 | 55.7 |
| P19 | 22.1 | 0.65 (PTC 3) | 0.92 | 59.6 |

### 35% PAA (Evonik™):

Table 10 shows results obtained using 35% PAA (Evonik™) as the oxidant. It is apparent from Table 10 that the quaternary salt phase transfer catalysts also work with peracetic acid oxidant to improve bromine recovery.

TABLE 10
IIR (25 wt %), Water (6 wt %), Temperature
(45° C.), Br₂ (0.034 moles), 600 rpm, 5 min

| | PAA | | Functional | BAE |
|---|---|---|---|---|
| Process | (mL) | PTC (mmol) | Br (mol %) | (%) |
| C1 | 0 | 0 | 0.56 | 36.3 |
| C9 | 3.8 | 0 | 0.84 | 54.5 |
| P20 | 3.8 | 0.65 (PTC 3) | 0.92 | 59.6 |

### In-Situ Formed PAA:

Table 11 shows results obtained using in-situ formed PAA as the oxidant. In-situ PAA was prepared from 5.5 mL 30% H₂O₂, 10.5 mL acetic acid and 0.5 mL H₂SO₄. It is apparent from Table 11 that the quaternary salt phase transfer catalysts also work with in-situ formed peracetic acid oxidant to improve bromine recovery.

TABLE 11
IIR (25 wt %), Water (6 wt %), Temperature
(45° C.), Br₂ (0.034 moles), 600 rpm, 5 min

| | in-situ | | Functional | BAE |
|---|---|---|---|---|
| Process | PAA (mL) | PTC (mmol) | Br (mol %) | (%) |
| C1 | 0 | 0 | 0.56 | 36.3 |
| C10 | * | 0 | 0.79 | 51.2 |
| P21 | * | 0.79 (PTC 3) | 0.87 | 56.4 |

* See preparation method above.

### Hydrogen Peroxide:

Table 12 shows results obtained using hydrogen peroxide as the oxidant. It is apparent from Table 12 that that the quaternary salt phase transfer catalysts also work with hydrogen peroxide oxidant to improve bromine recovery

TABLE 12
IIR (25 wt %), Water (6 wt %), Temperature
(45° C.), Br₂ (0.034 moles), 600 rpm, 5 min

| | H₂O₂ | | Functional | BAE |
|---|---|---|---|---|
| Process | (mL) | PTC (mmol) | Br (mol %) | (%) |
| C1 | 0 | 0 | 0.56 | 36.3 |
| C11 | 5.5 | 0 | 0.75 | 48.6 |
| P22 | 5.5 | 0.65 (PTC 3) | 0.83 | 53.8 |

The novel features will become apparent to those of skill in the art upon examination of the description. It should be understood, however, that the scope of the claims should not be limited by the embodiments, but should be given the broadest interpretation consistent with the wording of the claims and the specification as a whole.

What is claimed is:

1. A process for producing a halogenated isoolefin copolymer, the process comprising contacting an unsaturated isoolefin copolymer cement, the cement comprising an unsaturated isoolefin copolymer dissolved in an organic solvent, under halogenation conditions with a halogenating agent and an aqueous solution of an oxidant and a phase transfer catalyst to form a two-phase reaction medium comprising an organic phase and an aqueous phase, the oxidant capable of converting hydrogen halide to free halogen and the phase transfer catalyst being a compound of Formula (I): 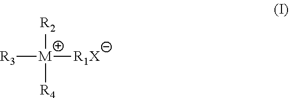
where:
M⁺ is a cation of a Group VA element;
X⁻ is an anion that dissociates from the cation in an aqueous solution; and,
R₁, R₂, R₃ and R₄ are the same or different and are independently a C₁₋₃₀ organic moiety.

2. The process of claim 1, wherein the Group VA element is N or P.

3. (canceled)

4. The process of claim 1, wherein the anion is a halide, OH⁻, HSO₄⁻, BF₄⁻, NO₃⁻, CF₃SO₃⁻, CH₃C₆H₄SO₃⁻, CH₃COO⁻, ICl₂⁻, ClO₄⁻, SO₄²⁻, SCN⁻, PF₆⁻ or HF₂⁻.

5. (canceled)

6. The process of claim 1, the C₁₋₃₀ organic moiety comprises an aliphatic hydrocarbyl moiety, an aromatic hydrocarbyl moiety or both an aliphatic hydrocarbyl moiety and an aromatic hydrocarbyl moiety.

7. (canceled)

8. The process of claim 1, wherein R₁, R₂, R₃ and R₄ together comprise a total of 25 or more carbon atoms.

9. The process of claim 1, wherein the compound of Formula (I) is tetramethylammonium hydroxide, ethyl trimethylammonium iodide, triethylmethylammonium chloride, tetraethylammonium hydrogen sulfate, tetraethylammonium chloride, tetrabutylammonium bromide, tetrabutylammonium hydrogensulfate, n-octyltrimethylammonium chloride, methyltrioctylammonium hydrogen sulfate, tetrahexylammonium hydrogensulfate, tetra-n-octylammonium iodide, diauryldimethylammonium bromide, or mixtures thereof.

10. The process of claim 1, wherein the oxidant comprises hydrogen peroxide, metal salts of hydrogen peroxide, organic peracids, metal salts of organic peracids, inorganic oxyacids, metal salts of inorganic oxyacids or mixtures thereof.

11. (canceled)

12. (canceled)

13. (canceled)

14. The process of claim 1, wherein the phase transfer catalyst and the oxidant are present in the aqueous solution in a molar ratio of phase transfer catalyst to oxidant of 0.005 or more.

15. The process of claim 1, wherein the phase transfer catalyst is present in the aqueous solution in an amount of at least 0.13 mmol.

16. The process of claim 1, wherein the reaction medium is stirred with a mechanical stirrer at 600 rpm or more.

17. The process of claim 1, wherein the cement has a water content of 1 wt % or greater based on total weight of the cement.

18. The process of claim 17, wherein the water content of the cement is 1.5 wt % or greater.

19. (canceled)

20. (canceled)

21. The process of claim 1, wherein the unsaturated isoolefin copolymer cement is produced by polymerizing at least one isoolefin monomer and at least one copolymerizable unsaturated monomer in an organic diluent and removing the organic diluent and residual monomers by flash separation with steam.

22. (canceled)

23. The process of claim 21, wherein the at least one isoolefin monomer is isobutene and the at least one copolymerizable unsaturated monomer is isoprene, and the unsaturated isoolefin copolymer further comprises one or more additional copolymerizable monomers selected from the group consisting of α-methyl styrene, p-methyl styrene, chlorostyrene, cyclopentadiene, methylcyclopentadiene and indene.

24. The process of claim 21, wherein the organic diluent comprises methyl chloride.

25. The process of claim 1, wherein the unsaturated isoolefin copolymer is present in the reaction medium in an amount of 10-33 wt %, based on total weight of the reaction medium.

26. The process of claim 1, wherein the contacting the unsaturated isoolefin copolymer cement with the halogenating agent is conducted for 1-60 minutes at a temperature in a range of 20-45° C.

27. (canceled)

28. The process of claim 1, wherein
the Group VA element is N or P, preferably N;
the anion is OH⁻ or HSO4;
the C₁₋₃₀ organic moiety is a C₁₋₃₀ linear alkyl moiety; the compound of Formula (I) is tetramethylammonium hydroxide, ethyl trimethylammonium iodide, triethylmethylammonium chloride, tetraethylammonium hydrogen sulfate, tetraethylammonium chloride, tetrabutylammonium bromide, tetrabutylammonium hydrogensulfate, n-octyltrimethylammonium chloride, methyltrioctylammonium hydrogen sulfate, tetrahexylammonium hydrogensulfate, tetra-n-octylammonium iodide, diauryldimethylammonium bromide, or mixtures thereof;
R₁, R₂, R₃ and R₄ together comprise a total of 25 or more carbon atoms; and
the oxidant comprises H₂O₂, NaHSO₅, Na₂S₂O₈, NaClO, NaBrO, NaBrO₃, NaIO₃, NaClO, NaClO₃, NaClO₄, NaIO₄, NaOO(CO)R₅ where R₅ is a C₁₋₈ alkyl moiety, KHSO₅, K₂S₂O₈, KClO, KBrO, KBrO₃, KIO₃, KClO₃, KClO₄, KIO₄, KOO(CO)R₅, compounds that generate the aforementioned oxidants, or mixtures thereof.

29. The process of claim 14, wherein
the phase transfer catalyst is present in the aqueous solution in an amount of at least 0.13 mmol;
the water content of the cement is 2-20 wt %;
the unsaturated isoolefin copolymer cement is produced by polymerizing isobutene and isoprene, p-methyl styrene or β-pinene, in an organic diluent and removing the organic diluent and residual monomers by flash separation with steam, optionally wherein the unsaturated isoolefin copolymer further comprises one or more additional copolymerizable monomers selected from the group consisting of α-methyl styrene, p-methyl styrene, chlorostyrene, cyclopentadiene, methylcyclopentadiene and indene.

30. The process of claim 29, wherein the organic diluent comprises methyl chloride, the halogenating agent is Br₂, the unsaturated isoolefin copolymer is present in the reaction medium in an amount of 10-33 wt %, based on total weight of the reaction medium; wherein the contacting the unsaturated isoolefin copolymer cement with the halogenating agent is conducted for 1-60 minutes at a temperature in a range of 20-45° C.
